(19) United States
(12) Patent Application Publication
(10) Pub. No.: US 2021/0031825 A1
(43) Pub. Date: Feb. 4, 2021

(54) STEERING SYSTEM WITH A GUIDE OF A SHOCK ABSORPTION BLADE

(71) Applicant: JTEKT EUROPE, Irigny (FR)

(72) Inventors: Laurent REY, Villeurbanne (FR); Sylvain DUHAMEL, Lyon (FR); Boris CATHERIN, Décines (FR)

(73) Assignee: JTEKT EUROPE, Irigny (FR)

(21) Appl. No.: 16/943,112

(22) Filed: Jul. 30, 2020

(30) Foreign Application Priority Data
Jul. 30, 2019 (FR) 19/08681

(51) Int. Cl. B62D 1/19; B62D 1/181

(52) U.S. Cl. CPC B62D 1/195; B62D 1/181

(57) ABSTRACT

A steering system for a motor vehicle, including a steering casing, having a hollow guide conduit extending along a longitudinal axis, a steering column including an upper tube, disposed in the guide conduit and displaceable in translation relative to the steering casing along the longitudinal axis mounted on the steering casing and driving a drive member in displacement parallel to the longitudinal axis, an absorption blade including a first portion, secured to the upper tube, and a second portion, secured to the drive member, the first portion and the second portion extending parallel to the longitudinal axis opposite to each other and being connected by a bent portion, the second portion has at least one stop in contact with the first portion, so as to prevent a relative approaching between the second portion and the first portion.

The present invention concerns a steering system for a motor vehicle, designed to absorb an energy during a frontal shock.

The motor vehicles usually include a steering system allowing a driver to steer it.

Such a steering system includes in particular a steering column connected, at one of the ends thereof, to a steering wheel and, at another of the ends thereof, to a rack associated to the wheels of the motor vehicle: the steering column is thus adapted to transmit a rotational movement of the steering wheel to the rack, which then converts this rotational movement into a pivoting of the wheels of the motor vehicle.

In addition, it is provided that the driver can axially displace the steering wheel by moving it closer to or away from the dashboard of the motor vehicle, in order to adapt the position of this steering wheel to its size and driving habits. This axial displacement of the steering wheel is made possible by the structure of the steering column which comprises:
an upper shaft and an intermediate shaft which are coaxial along a longitudinal axis, linked in rotation and movable in translation axially relative to each other; and
an upper tube and a lower tube which are coaxial along the longitudinal axis, linked in rotation and movable in translation axially relative to each other, where the upper shaft is mounted movable in rotation inside the upper tube, and is linked in translation axially to the upper tube.

Moreover, the upper tube is disposed in a guide conduit of a steering casing (also called column support, secured to the structure of the motor vehicle) and is displaceable in translation, along the longitudinal axis, relative to this steering casing.

In many motor vehicles, the axial displacement of the steering wheel is carried out thanks to electric actuation means, mounted on the steering casing and allowing driving in translation the upper tube (integrally with the upper shaft) relative to the steering casing and also relative to the lower tube which is fixed.

It should be noted that, in the case of autonomous type motor vehicles, the steering wheel should perform an axial displacement at each transition between a manual driving mode (where the driver steers the motor vehicle thanks to the steering wheel) and an autonomous driving mode (where the driver no longer steers the motor vehicle and the driving of the motor vehicle is automated): the steering wheel is moved closer to the dashboard towards a position called « retracted» position when switching to autonomous mode, in order to give more space to the driver in the passenger compartment of the motor vehicle, and moved closer to the driver when switching to manual mode.

For these autonomous motor vehicles, which are more and more widespread, the steering wheel is thus caused to carry out a large number of axial displacements of large amplitude during a «normal» use thereof, strongly requesting the means for actuating the steering system.

In addition, it is also provided that the steering wheel performs an axial displacement towards the retracted position during a frontal shock resulting in an impact of the driver against the steering wheel.

Indeed, in the case of a frontal shock undergone by the motor vehicle during an accident, the driver of the motor vehicle is thrown towards the steering wheel. The shock of the driver against the steering wheel is then transmitted to the steering column: by performing a translational displacement relative to the steering casing, the upper tube allows absorbing a portion of the energy transmitted to the steering wheel during the impact with the driver, thus reducing the intensity of this impact for the driver.

The upper tube of the steering column should thus be adapted to perform a translational movement in the context of a «normal» use of the motor vehicle, under the effect of the actuating means when adjusting the position of the steering wheel, and in the context of an «accidental» use, under the effect of the impact of the driver against the steering wheel in the case of a frontal shock.

In order to meet these two constraints of use, it is known to use a deformable absorption blade, being in the form of a blade bent at 180° and having two portions parallel to each other, connected by a bent portion, a first portion of these portions being fastened on the upper tube, a second portion of these portions being connected to the drive means via a drive member.

In the context of a «normal» adjustment of the position of the steering wheel, the actuating means exert, on the second portion, via the drive member, a low intensity force: the blade retains its initial shape and remains rigid, transmitting, to the upper tube, the force exerted by the actuating means on the drive member and driving the upper tube in translation relative to the steering casing.

During an accident, the driver exerts, on the steering wheel, a force of significant intensity, directly transmitted to the upper tube then, to the first portion of the blade: under the effect of this high intensity force, the blade undergoes a deformation during which the first portion is driven along the longitudinal axis by the upper tube, causing the bent portion to be «displaced» along the blade, so as to lengthen the first portion and shorten the second portion.

By this deformation, the blade thus allows a displacement of the upper tube along the longitudinal axis, while absorbing the impact force by its deformation.

Moreover, it is advantageous that the blade is positioned so that, throughout its deformation, the first portion and the second portion remain well parallel to each other, in order to allow a regular and progressive absorption of the energy transmitted to the upper tube during an accident.

However, in practice, due to manufacturing defects in the steering casing (commonly made of aluminum), and in particular due to the presence of a small clearance angle between the upper tube and the walls of the guide conduit in which it is disposed, it is difficult to guarantee a good parallelism between the two portions of the absorption blade and the longitudinal axis along which the upper tube is driven in translation: therefore, during the deformation of the absorption blade in an accident, the first portion and the second portion do not remain parallel to each other.

Thus, an inaccuracy in the positioning of the absorption blade or in the dimensioning of the steering casing or the upper tube leads to a break in the parallelism between the two portions of the blade during the deformation thereof and, finally, to an irregular absorption of the energy transmitted to the upper tube during an impact of the driver against the steering wheel, resulting in a degraded protection of the driver in the case of an accident.

The present invention aims at solving all or part of these drawbacks, by proposing a steering system for a motor vehicle allowing guaranteeing a good parallelism of the two portions of the blade throughout the deformation thereof, in the case of an accident of the motor vehicle.

Another object of the invention is to propose such a steering system, in which a guide of the portions of the blade during the deformation thereof is carried out thanks to a limited number of guide parts.

Yet another object of the invention is to provide such a steering system which is simple and cost-effective to implement.

To this end, it proposes a steering system for a motor vehicle, said steering system including:
a steering casing, having a hollow guide conduit extending along a longitudinal axis,
a steering column comprising an upper tube coupled to a steering wheel, disposed in the guide conduit and displaceable in translation relative to the steering casing along the longitudinal axis thanks to motorized actuating means, mounted on said steering casing and driving a drive member in displacement parallel to the longitudinal axis,
an absorption blade, provided to undergo a deformation under the effect of a shock exerted on the steering wheel along the longitudinal axis, said absorption blade including a first portion, secured to the upper tube, and a second portion, secured to the drive member, said first portion and said second portion extending parallel to the longitudinal axis opposite to each other and being connected by a bent portion,

said steering system being characterized in that said second portion has at least one stop in contact with said first portion, so as to prevent a relative approximation between said second portion and said first portion.

The invention thus proposes to integrate into the absorption blade one or more specific shapes arranged between the first portion and the second portion, in order to to prevent a break in the parallelism between the latter due to an approaching between the first portion and the second portion.

More particularly, the absorption blade has, in profile view, a generally «U»-shaped section, each of the branches of this «U» being formed respectively by the first portion and the second portion. This first portion and this second portion are parallel to each other (and, ideally, parallel to the longitudinal axis) and define an interstitial space therebetween: the invention therefore proposes integrating, into the second portion, a specific shape forming a stop extending in the interstitial space and in the direction of the first portion, so as to come into physical contact with this first portion.

During an accident, as previously described, the upper tube, guided in the guide conduit of the steering casing, performs a translational movement along the longitudinal axis and drives the first portion of the absorption blade with it, causing a deformation of the same absorption blade.

However, it is possible that, due to inaccuracies during the manufacture of the steering casing or during the positioning of the absorption blade, the first portion and the second portion are not strictly parallel with the longitudinal axis: the first portion being driven along the same longitudinal axis, the translation of the upper tube in the guide conduit therefore has the effect of breaking the parallelism between the first portion and the second portion (remaining fixed, connected to the means for actuating the steering casing).

In the case where this breaking of parallelism would tend to result in a relative approaching between the first portion and the second portion, the presence of the stop(s) of the second portion in contact with the first portion physically prevents this approaching from occurring.

This or these stop(s) will thus be subjected to mechanical stresses in compression but will be advantageously designed to resist these mechanical forces without undergoing a deformation, so that the first portion and the second portion remain permanently parallel to each other.

It should be noted that, before any deformation of the absorption blade, the first portion and the second portion are perfectly parallel to each other and are thus separated from each other by a constant reference gap distance over their entire length: the present application designates by the term «approaching» the fact that, at a point of the absorption blade, the distance separating the first portion from the second portion is less than the reference gap distance.

Conversely, the term «distance» designates the fact that, at a point on the absorption blade, the distance separating the first portion from the second portion is greater than the reference gap distance.

The absorption blade can thus undergo a deformation resulting in both an approaching and a distance between the first portion and the second portion, at different points thereof.

It should also be noted that the concept of physical «contact» between two elements is defined in the present application, for the mounting clearances: there may, for example, exist, in practice, a very small clearance between the stop(s) of the second portion and the first portion, such that an approaching between the first portion and the second portion will result in an immediate physical contact of the stop(s) against the first portion without breaking the parallelism between this first portion and this second portion.

In one embodiment, the first portion and the second portion each have an upper end and a lower end, the bent portion of the absorption blade joining said upper ends to each other, and in which the stop(s) of the second portion is/are disposed in the vicinity of the lower end of said second portion.

Indeed, the respective lower ends of the first portion and the second portion being distant from the bent portion, the absorption blade is very likely to be deformed in the vicinity of the latter, since a force of low intensity may be sufficient to bring them closer to each other.

By placing the stop as far as possible from the bent portion joining the first portion and the second portion, it is thus possible to prevent an approaching of the latter at their respective lower ends.

According to one possibility, the stop(s) is/are linear and extend parallel to the longitudinal axis.

In this manner, the mechanical compression forces exerted on this or these stop(s) are distributed over a larger area and the absorption blade can thus withstand the approaching between the first portion and the second portion under the effect of more intense mechanical forces, this first portion and this second portion being in fact «supported » over a greater length.

In a variant, the second portion has a strip provided with two opposite longitudinal sides, and two lateral wings, folded along said respective longitudinal sides towards the first portion, said lateral wings having longitudinal edges forming the stops.

Thus, the folded lateral wings of the second portion are in contact with the first portion and prevent an approaching between this first portion and this second portion.

It is possible that these lateral wings extend over the entire length of the second portion (measured between the upper end thereof and the lower end thereof, or over one or more segments thereof.

Advantageously, these lateral wings are symmetrical relative to a plane of symmetry containing the longitudinal axis, so as not to create mechanical shearing forces in the absorption blade during the deformation of the latter.

According to one possibility, the lateral wings of the second portion are parallel to each other and orthogonal to the first portion.

These lateral wings thus offer the best resistance to an approaching between the first portion and the second portion.

According to another possibility, the first portion has a strip provided with two opposite longitudinal sides, and two lateral protrusions protruding from said respective longitudinal sides and extending coplanar with said strip, and in which the longitudinal edges of the lateral wings of the second portion are in contact with the respective lateral protrusions of the first portion.

In this manner, it is possible to create a physical contact between the lateral wings of the second portion and the first portion, in the case where the strip of the first portion and the strip of the second portion have an equal width (that is to say the case where the absorption blade is in the form of a «ribbon» of constant width bent on itself at 180°) and where these lateral wings extend orthogonally to the first portion.

In one embodiment, the steering system includes a guide rail secured to the upper tube and the first portion, said guide rail extending parallel to the longitudinal axis and being adapted to:
guide the absorption blade in its deformation under the effect of a shock exerted on the upper tube along the longitudinal axis, and
prevent a relative distance between the second portion and the first portion.

In the same manner that the presence of the stop(s) of the second portion prevents an approaching between the first portion and the second portion, the presence of a physical contact between the longitudinal flanges of the guide rail and the outer face of the second portion prevents a distance between the first portion and the second portion.

Thus, when the guide rail is combined with the previously described stop(s), the steering system according to the invention allows preventing both a distance and an approaching between the first portion and the second portion: the latter remain therefore well parallel throughout the deformation of the absorption blade, thus guaranteeing a better protection of the driver of the motor vehicle in the case of an accident, the energy of the shock of the latter against the steering wheel being absorbed more regularly.

The parallelism of the second portion and the first portion is thus guaranteed by the presence of a single guide part (the guide rail) external to the guide blade, the stop(s) (preventing an approaching between the first portion and of the second portion) forming an integral part of the second portion.

It should be noted that this guide rail has the function, in the context of a «normal» adjustment of the position of the steering wheel thanks to the actuating means, of guiding the absorption blade in translation in a direction parallel to the longitudinal axis, without subjecting said absorption blade to a deformation.

According to one feature of the invention, the second portion has opposite inner face and outer face, where said inner face faces the first portion, and in which the guide rail has at least one stopper in contact with said outer face of the second portion.

According to one feature of the invention, the guide rail has a «U»shaped section, by comprising:
a central portion secured to the upper tube and on which the first portion is fastened, and
two opposite branches between which the absorption blade is disposed,

where said branches are provided with respective folded longitudinal flanges, each of said folded longitudinal flanges extending parallel to the first portion and forming a stopper in contact with the outer face of the second portion.

According to one possibility, the branches of the guide rail are in contact with the respective lateral wings of the second portion.

This contact, taking place over an extended area, thus allows a good guiding in translation of the absorption blade inside the guide rail, in the context of a «normal» adjustment of the position of the steering wheel thanks to the actuating means.

According to another possibility, the lateral protrusions of the first portion are positioned in abutment against the respective branches of the guide rail.

In one embodiment, the first portion and the second portion of the absorption blade define an empty interstitial space therebetween, devoid of element in simultaneous contact with the first portion and the second portion.

In particular, this interstitial space is not occupied by a spacer fulfilling the same objective as the stop(s) of the steering system according to the invention, namely preventing an approaching between the first portion and the second portion.

The absence of this spacer therefore allows simplifying the structure of the steering system and reducing the cost thereof, since the latter includes fewer different parts.

According to one possibility, the actuating means comprise a geared motor, mounted on the steering casing and allowing driving in rotation a worm screw about a direction parallel to the longitudinal axis, said worm screw cooperating with the drive member, fastened on the second portion of the absorption blade, so as to drive said second portion in a translational movement in a direction parallel to the longitudinal axis.

Other features and advantages of the present invention will appear on reading the detailed description below, of a non-limiting example of implementation, made with reference to the appended figures in which:

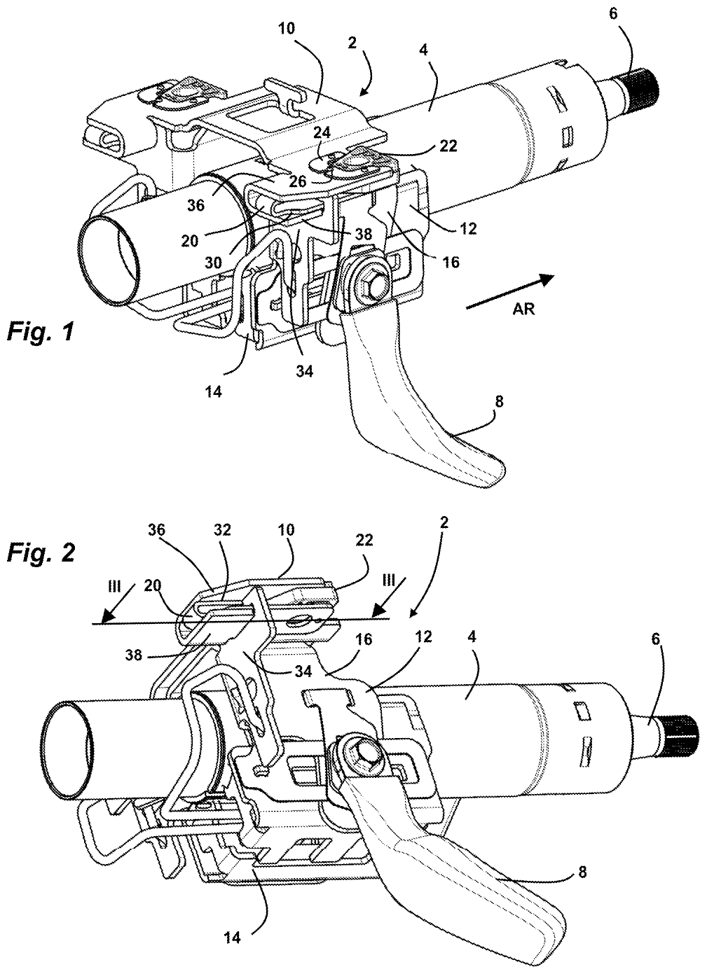

FIG. 1 is an exploded view of a steering system according to the invention;

FIG. 2 is a perspective view of an upper tube, a guide rail and an absorption blade according to the invention;

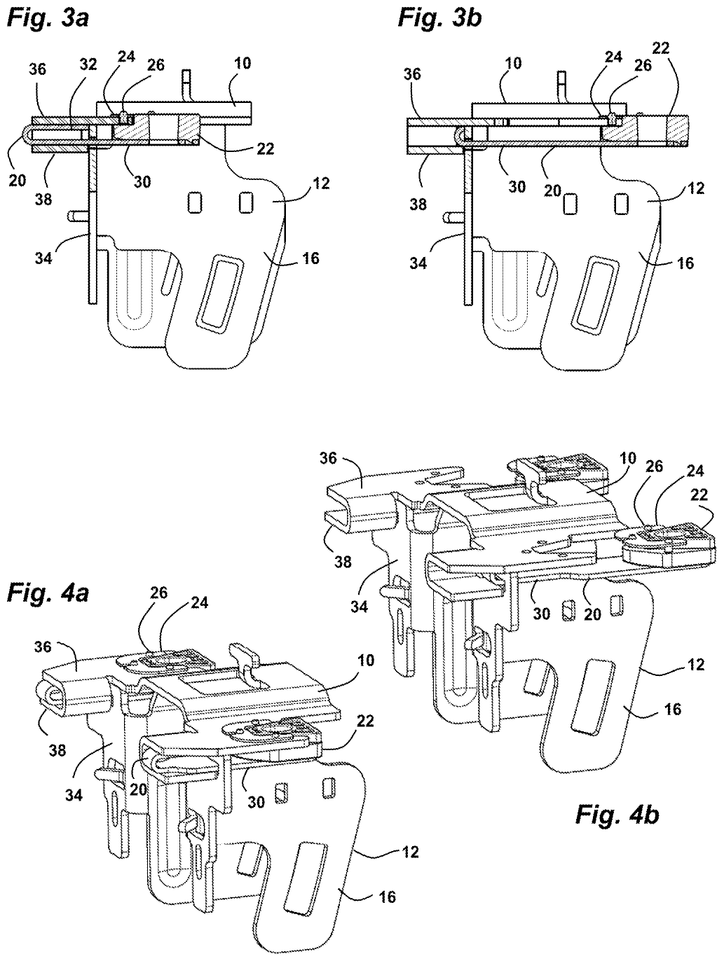

FIGS. 3a and 3b are detailed views of an absorption blade according to the invention;

FIGS. 4a and 4b are detailed views of a guide rail according to the invention.

With reference to FIG. 1, a steering system 1 according to the invention includes a steering casing 2 having a hollow guide conduit 21, this guide conduit 21 extending along a longitudinal axis D and having a circular section.

An upper tube 3 is disposed in these guide conduits 21, such that this upper tube 3 is displaceable in translation, in the guide conduit 21, relative to the steering casing 2 along the longitudinal axis D.

On this upper tube 3 a guide rail 4 is fastened, inside which an absorption blade 5 is positioned.

The particular features of this guide rail 4 and of this absorption blade 5 will be described further below.

The absorption blade 5 includes a first portion 51 and a second portion 52 connected by a bent portion 53, the first portion 51 and the second portion 52 being parallel to each other and parallel to the longitudinal axis D.

The first portion 51 is fastened on a central portion 41 of the guide rail 4, while the second portion 52 is fastened, thanks to screws 6, to a drive member 7 at a lower end 521.

A perspective view of the upper tube 3, the guide rail 4 and the absorption blade 5 is shown in FIG. 2.

The drive member 7 cooperates with actuating means (not represented), mounted on the steering casing 2 and adapted to displace the drive member 7 in a drive direction D′ parallel to the longitudinal axis D.

For example, the actuating means may comprise a geared motor shown on a platform 22 of the steering casing 2, this geared motor allowing driving in rotation, about the drive direction D′, a worm screw cooperating with a tapped hole 71 of the drive member 7, so as to drive the latter in translation along the drive direction D′.

Thus, the actuating means allow, via the drive member 7 and the absorption blade 5, driving the upper tube 3 in translation along the longitudinal axis D.

This first operating mode of the steering system 1 according to the invention corresponds to a «normal» adjustment mode of the axial position of the steering wheel of a motor vehicle, for example when switching from a manual driving mode to an autonomous driving mode for an autonomous type motor vehicle.

In this first mode of operation, the translational movement of the upper tube 3 is triggered by a low intensity force exerted on the second portion 52 of the absorption blade 5 by the actuating means 7 (via the drive member).

Under the effect of this low intensity force, the absorption blade 5 remains rigid and retains its initial shape without undergoing a deformation, transmitting this force to the guide rail 4 then to the upper tube 3.

In a second «accidental» operating mode of the steering system 1 according to the invention, following a frontal shock undergone by the motor vehicle, a high intensity force is exerted on the upper tube 3 along the longitudinal axis D, due to an impact of the driver against the steering wheel mounted on the upper tube 3.

This force is transmitted, via the guide rail 4, to the first portion 51 of the absorption blade 5.

Under the effect of this significant effort, the absorption blade 5 undergoes a deformation inside the guide rail 4, in order to allow a translational movement of the upper tube 3 along the longitudinal axis D: this translational movement allows absorbing a portion of the shock undergone by the driver of the motor vehicle during his impact against the steering wheel.

More specifically, during this deformation, the first portion 51 is driven in translation parallel to the longitudinal axis by the upper tube 3, while the upper end 521 of the second portion 52, secured to the drive member 7 itself connected to the actuating means, remains stationary: the first portion 51 is thus forced to advance parallel to the longitudinal axis D and in the direction of the lower end 521 of the second portion 52, thus causing a displacement of the bent portion 53 along the absorption blade 5, also in the direction of the lower end 521.

Thus, the first portion 51 undergoes an elongation and the second portion 52 undergoes a shortening during the deformation of the absorption blade 5, this first portion 51 and this second portion 52 remaining parallel to the longitudinal axis D.

It is important to note that this specific deformation of the absorption blade 5 is made possible by the particular structure of the absorption blade 5 and the guide rail 4, which allows forcing the particular displacement of the first portion 51, from the second portion 52 and the bent portion 53.

Indeed, as shown in FIG. 3, the second portion 52 includes a strip 522 provided with two folded lateral wings 523 along two opposite longitudinal sides 524: these longitudinal wings 523 are parallel to each other and extend towards the first portion 51, orthogonally to the same first portion 51.

Moreover, the first portion 51 has a strip 511 provided with two opposite longitudinal sides 512, each of these longitudinal sides 512 including a lateral protrusion 513 coplanar with the first portion 51.

The absorption blade 5 is configured so that each of the lateral wings 523 has a longitudinal edge 526 in contact with one of the lateral protrusions 513, these lateral wings 523 thus forming a stop between the second portion 52 and the first portion 51.

Due to the contact between the lateral wings 523 and the first portion 51, the first portion 51 and the second portion 52 cannot be brought closer to each other during the deformation of the absorption blade 5, the presence of the lateral wings 523 between the second portion 52 and the first portion 51 physically blocking such an approaching.

On the other hand, as shown in FIG. 4, the guide rail 4 has a central portion 41 (on which the first portion 51 is fastened) and two branches 42 parallel to each other and orthogonal to the central portion 41.

Each of these branches 42 includes a folded longitudinal flange 43 extending parallel to the central portion 41 (and therefore, parallel to the first portion 51): this guide rail 4 is shaped so that the longitudinal flanges 43 are in contact with an upper face 525 of the second portion 52.

The longitudinal flanges 43 thus form a stopper allowing preventing a relative distance between the second portion 52 and the first portion 51.

In addition, as shown in FIG. 2, the lateral wings 523 of the absorption blade 5 are in contact with the branches 42 of the guide rail 4.

Thus, the deformation of the absorption blade is guided by the combination of three constraints:
the contact between the lateral wings 523 of the absorption blade 5 and the branches 42 of the guide rail 4 prevents any lateral displacement of the second portion 52 and of the first portion 51, which can be displaced in translation only parallel to the longitudinal axis D,
the contact between the lateral wings 523 and the protrusions 513 prevents any approaching between the first portion 51 and the second portion 52, and
the contact between the longitudinal flanges 43 and the outer face 525 of the second portion 52 prevents any relative distance between the first portion 51 and the second portion 52.

When a significant force is exerted on the upper tube 3 along the longitudinal axis D, the absorption blade 5 is then forced to be deformed in the previously described manner due to these three constraints.

In particular, the first portion 51 and the second portion 52 remain permanently parallel to each other during this deformation, and the bent portion 53 maintains a constant radius of curvature: this feature allows a regular absorption of the shock undergone by the driver of the motor vehicle during his impact against the steering wheel, leading to better protection of the latter.

The steering system 1, according to the invention, therefore allows ensuring that the deformation of the absorption blade 5 in the case of an accident is carried out so that the first portion 51 and the second portion 52 remain parallel to each other, using only one guide rail 4 and a specific shape secured to the absorption blade 5.

1. A steering system for a motor vehicle, said steering system including:
a steering casing, having a hollow guide conduit extending along a longitudinal axis,
a steering column comprising an upper tube coupled to a steering wheel, disposed in the guide conduit and displaceable in translation relative to the steering casing along the longitudinal axis thanks to motorized actuating means, mounted on said steering casing and driving a drive member in displacement parallel to the longitudinal axis,
an absorption blade, provided to undergo a deformation under the effect of a shock exerted on the steering wheel along the longitudinal axis, said absorption blade including a first portion, secured to the upper tube, and a second portion, secured to the drive member, said first portion and said second portion extending parallel to the longitudinal axis opposite to each other and being connected by a bent portion,
said steering system wherein said second portion has at least one stop in contact with said first portion, so as to prevent a relative approaching between said second portion and said first portion.

2. The steering system according to claim 1, wherein the first portion and the second portion each have an upper end and a lower end, the bent portion of the absorption blade joining said upper ends to each other, and wherein the stop(s) of the second portion is/are disposed in the vicinity of the lower end of said second portion.

3. The steering system according to claim 1, wherein the stop(s) is/are linear and extend parallel to the longitudinal axis.

4. The steering system according to claim 1, wherein the second portion has a strip provided with two opposite longitudinal sides, and two lateral wings, folded along said respective longitudinal sides towards the first portion, said lateral wings having longitudinal edges forming the stops.

5. The steering system system according to claim 4, wherein the lateral wings of the second portion are parallel to each other and orthogonal to the first portion.

6. The steering system according to claim 4, wherein the first portion has a strip provided with two opposite longitudinal sides, and two lateral protrusions protruding from said respective longitudinal sides and extending coplanar with said strip, and wherein the longitudinal edges of the lateral wings of the second portion are in contact with the respective lateral protrusions of the first portion.

7. The steering system according to claim 1, including a guide rail secured to the upper tube and the first portion, said guide rail extending parallel to the longitudinal axis and being adapted to:
guide the absorption blade in its deformation under the effect of a shock exerted on the upper tube along the longitudinal axis, and
prevent a relative distance between the second portion and the first portion.

8. The steering system according to claim 7, wherein the second portion has opposite inner face and outer face, where said inner face faces the first portion, and wherein the guide rail has at least one stopper in contact with said outer face of the second portion.

9. The steering system according to claim 8, wherein the guide rail has a «U»-shaped section, by comprising:
a central portion secured to the upper tube and on which the first portion is fastened, and
two opposite branches between which the absorption blade is disposed,
wherein said branches are provided with respective folded longitudinal flanges, each of said folded longitudinal flanges extending parallel to the first portion and forming a stopper in contact with the outer face of the second portion.

10. The steering system according to claim 4, wherein the branches of the guide rail are in contact with the respective lateral wings of the second portion.

11. The steering system according to claim 6, wherein the lateral protrusions of the first portion are positioned in abutment against the respective branches of the guide rail.

12. The steering system according to claim 1, wherein the first portion and the second portion of the absorption blade define an empty interstitial space therebetween, devoid of element in simultaneous contact with the first portion and the second portion.

13. The steering system according to claim 1, wherein the motorized actuating means comprise a geared motor, mounted on the steering casing and allowing driving in rotation a worm screw about a direction parallel to the longitudinal axis, said worm screw cooperating with the drive member, fastened on the second portion of the absorption blade, so as to drive said second portion in a translational movement in a direction parallel to the longitudinal axis.
